(19) United States
(12) Patent Application Publication
(10) Pub. No.: US 2012/0040175 A1
(43) Pub. Date: Feb. 16, 2012

(54) COATED SUBSTRATE

(76) Inventors: Simon James Hurst, Lancashire (GB); Troy Manning, Lancashire (GB); Peter Dobson, Oxfordshire (GB); Steve Sheard, Oxfordshire (GB); Peter Bishop, Oxfordshire (GB); Ivan Parkin, Greater London (GB)

(21) Appl. No.: 13/138,690

(22) PCT Filed: Mar. 19, 2010
(86) PCT No.: PCT/GB2010/050467

§ 371 Date: Oct. 28, 2011

(30) Foreign Application Priority Data
Mar. 20, 2009 (GB) 0904803.4

(51) Int. Cl. B32B 5/16; C23C 4/10; C03C 17/23; B05D 5/06; B05D 5/12

(52) U.S. Cl. 428/323; 427/162; 427/164; 427/126.3; 427/165; 427/453

(57) ABSTRACT

Methods for coating a substrate are disclosed, the methods comprising providing a substrate, providing pre-formed nanoparticles of an inorganic material, providing at least one precursor of a first metal oxide, and depositing a coating on at least one surface of the substrate by contacting the surface with the precursor of the metal oxide and pre-formed nanoparticles. Also disclosed are substrates coated using such a method. The coated substrates are coloured. Preferably the metal oxide is a doped metal oxide to modify the thermal properties of the coating. The preferred nanoparticles are of platinum group metals or coinage metals.

The present invention relates to methods for coating substrates, and to coated substrates in particular coated transparent substrates such as glass.

Coloured glass is generally prepared by adding tinting agents, usually metal oxides, to molten glass in closely controlled amounts. Metallic colouring agents have also been used. The Roman soda-lime-silica glass Lycurgus Cup is a famous example believed to have been manufactured in the 4^{th} century AD; analysis has revealed that the cup contains a colloidal alloy of gold and silver (Au—Ag, 40 ppm and 300 ppm respectively). The cup is ruby red in transmitted light and green in reflected light—these colours arise from the small amounts of embedded Au/Ag alloyed nanoparticles. The Romans formed these highly coloured objects by adding coins into the glass melt. The coins dissolved in the high temperature of the glass forming process and adventitiously formed alloyed nanoparticles embedded within the bulk glass matrix. The brilliant colours of metal nanoparticles are due to the surface plasmon resonance (SPR) absorption governed by the metal nanoparticles' morphology, size, shape and the dielectric constant of the surrounding medium (G Walters and I. P. Parkin J. Mater. Chem. 2009, 19 pp 574-590). G Walters and I. P. Parkin Appl. Surf. Sci (2009) (doi:10.1016/j:apsusc.2009.02.039) discuss methods of depositing coatings of nanoparticles in metal oxides using solution precursors of the nanoparticles and oxides.

Unfortunately, traditional methods of colouring glass have disadvantages, especially in large-scale glass production, because achieving the right colour after a colour change often takes a large amount of glass to be processed from the glass furnace leading to expense and delays. Methods of depositing nanoparticle coatings are also problematic because the known methods result in poor or inconsistent coatings, and may require very close control of the coating process.

It is an aim of the present invention to address these problems.

The present invention accordingly provides, in a first aspect, a method for coating a substrate, the method comprising,
a) providing a substrate
b) providing pre-formed nanoparticles of an inorganic material,
c) providing at least one precursor of a first metal oxide, and
d) depositing a coating on at least one surface of the substrate, by contacting the surface with the precursor of the metal oxide and pre-formed nanoparticles.

The result is deposition of a coating comprising the metal oxide and the pre-formed nanoparticles.

Preferably, the substrate is a transparent or a translucent substrate, most preferably glass or plastics.

The inorganic material will normally comprise a metal, usually a d-block metal and most preferably either a platinum group metal or a coinage metal. Platinum group metals include metals of Group 9 (cobalt, rhodium and iridium) and Group 10 (nickel, palladium and platinum) of the periodic table. Coinage metals are those metals of Group 11 of the periodic table (copper, silver and gold). Most preferably, the metal is selected from gold, silver, copper, nickel, palladium, platinum or an alloy thereof. Suitable alloys include alloys containing gold and silver, gold and copper, silver and copper or gold, silver and/or copper with other alloying metals, preferably d-block metals.

The nanoparticles are usually contained within an inorganic matrix. The inorganic matrix preferably comprises a matrix metal oxide.

The inorganic matrix containing the nanoparticles may be a separate layer to the first metal oxide layer of the coating; the coating would, therefore, have at least two layers.

However, in a preferred embodiment, the matrix metal oxide is the first metal oxide. This is advantageous because it provides colour in a single layer of the coating. Thus, in a preferred embodiment the coating method comprises depositing the coating as pre-formed nanoparticles in a matrix of the first metal oxide.

Surprisingly, the nature of the first metal oxide (e.g. as matrix) can significantly modify the colour properties of the nanoparticles by shifting the plasmon resonance of the nanoparticles towards the red end of the visual spectrum as the matrix refractive index is increased. Thus, modifying the amount and/or nature of the metal oxide (and/or any dopants if present) in the first metal oxide can significantly affect the colour of the coating provided by the nanoparticles.

Usually, the first metal oxide comprises an oxide of cerium, tin, aluminium, titanium, zirconium, zinc, hafnium or silicon. The preferred oxide for the first metal oxide is tin oxide. Zinc oxide is also advantageous. If zinc oxide is the first metal oxide it is preferred if the precursor is not Zn(acac)₂.

The first metal oxide may be doped. Preferred dopants include one or more of aluminium, gallium, fluorine, nitrogen, niobium or antimony to form a doped metal oxide. It is preferred if, when the doped metal oxide comprises tin oxide, it is doped with fluorine (providing a fluorine doped tin oxide) antimony and/or niobium. When the doped metal oxide is zinc oxide, it is preferred if the oxide is doped with aluminium or gallium. An advantage of this feature is that because the coating comprises both doped metal oxides and nanoparticles of an inorganic material, the interaction of the components is able to beneficially modify both the thermal (e.g. reflectance) properties and colour of the substrate. This is particularly advantageous because tinted glass often has problems when used for thermal control (i.e. to reduce transmission of heat energy either for solar control, for insulation, or both), because the tinted glass absorbs thermal energy, rather than reflecting the energy as in heat reflecting coatings.

The doped metal oxide is usually an electrically conductive doped metal oxide and is preferably substantially transparent (i.e. allowing light to pass without significant distortion). Such doped metal oxides are advantageous because they provide thermal control and, in particular, provide good infra-red reflectivity in the range of approximately 0.8 microns-3 microns. This, therefore, provides both solar control (by reflecting the heat component of the sun's energy) and also some insulation properties.

The metal oxide of the inorganic matrix (e.g. if it is not first metal oxide) will usually comprise an oxide of zinc, tin, titanium, silicon, zirconium, hafnium, cerium, indium or aluminium. One other possibility for the metal oxide is a solid solution of indium oxide and tin oxide (indium tin oxide e.g. 90% In₂O₃, 10% SnO2). The nature of the metal oxide depends upon the desired properties provided by the nanoparticles. As discussed above, it is possible to tune the colour provided by the nanoparticles by selecting the dielectric constant, including refractive index, of the inorganic matrix. Selection of the appropriate refractive index (and thickness) of metal oxide can therefore be of significant advantage.

The size of the nanoparticles also affects the colour and other properties of the nanoparticle component of the coating. Usually, the nanoparticles will have a particle size of 1 nm to 300 nm, 1 nm-150 nm, preferably 5-100 nm, or more preferably 10-80 nm, especially 10-60 nm and most preferably 20-50 nm.

The coating will usually have a thickness of 10-400 nm, preferably 20-300 nm. Each layer, in a multi-layer coating, will usually have a thickness of between 10 and 150 nm, depending both upon whether the particular layer contains doped metal oxides and/or nanoparticles and also depending upon the refractive index of each of the layers of the coating and their interaction in modifying the transmission and reflection properties of the transparent substrate.

Suitable techniques for coating include chemical vapour deposition, spray pyrolysis, aerosol spray pyrolysis, and/or flame spraying.

If the method is to be applied to glass on-line (i.e. during the production process for rolled or float glass), it is preferred if the method is on-line spray deposition or chemical vapour deposition, especially atmospheric pressure chemical vapour deposition (APCVD). On-line coating may take place in the float bath, lehr or lehr gap depending upon the optimum temperature and atmosphere for coating.

The temperature of deposition may be chosen from a wide range depending on precursor and coating method. Usually, the surface of the substrate will be at a temperature in the range 80° C. to 750° C., preferably 100° C. to 650° C., more preferably 100° C. to 600° C., most preferably 100° C. to 550° C.

Preferably, the coating method comprises depositing the coating as nanoparticles in a matrix of the first metal oxide. This may be achieved by co-depositing the doped metal oxide and nanoparticles at substantially the same time.

Alternatively, the nanoparticles (in an inorganic matrix, e.g. of a metal oxide) and the doped metal oxide may be deposited sequentially (in any order) in substantially separate layers.

In a second aspect, the present invention provides a substrate having a coating, the coating comprising a first metal oxide and pre-formed nanoparticles of an inorganic material.

The method and substrate of the two aspects of the invention are advantageous because they allow for substrates having colour in either transmission or reflection or both without the disadvantages of tinting the substrate itself.

The invention is illustrated by the accompanying drawings in which:

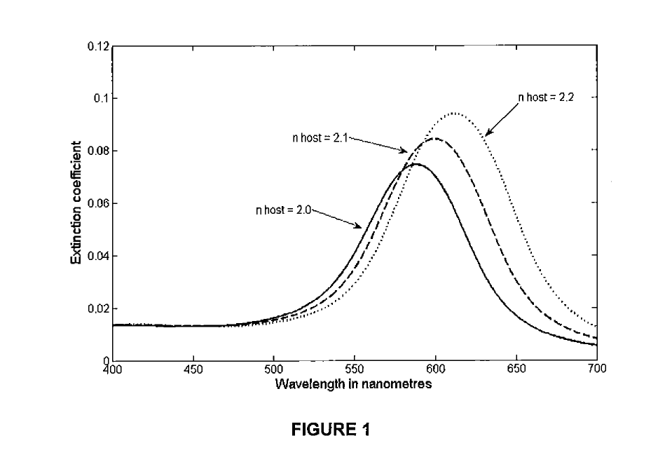

FIG. 1 illustrates the variation of plasmon resonance and red shift with increasing matrix refractive index.

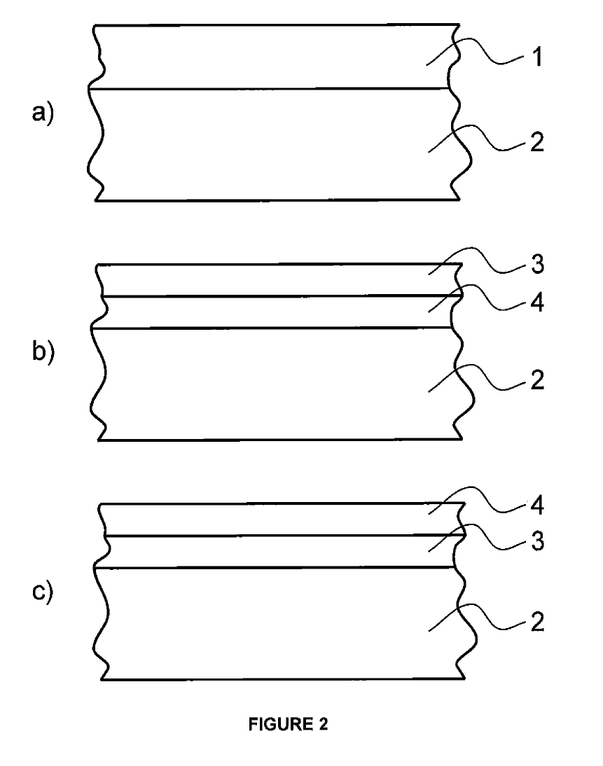

FIG. 2 illustrates configurations, according to the invention, of glass coatings for colouration and thermal control. Layer 1=a single nanoparticle in a doped metal oxide matrix, 2=glass substrate, 3=nanoparticles in a metal oxide layer with no doping to obtain colouration only and 4=transparent conducting oxide with no nanoparticle aggregate to obtain thermal control only.

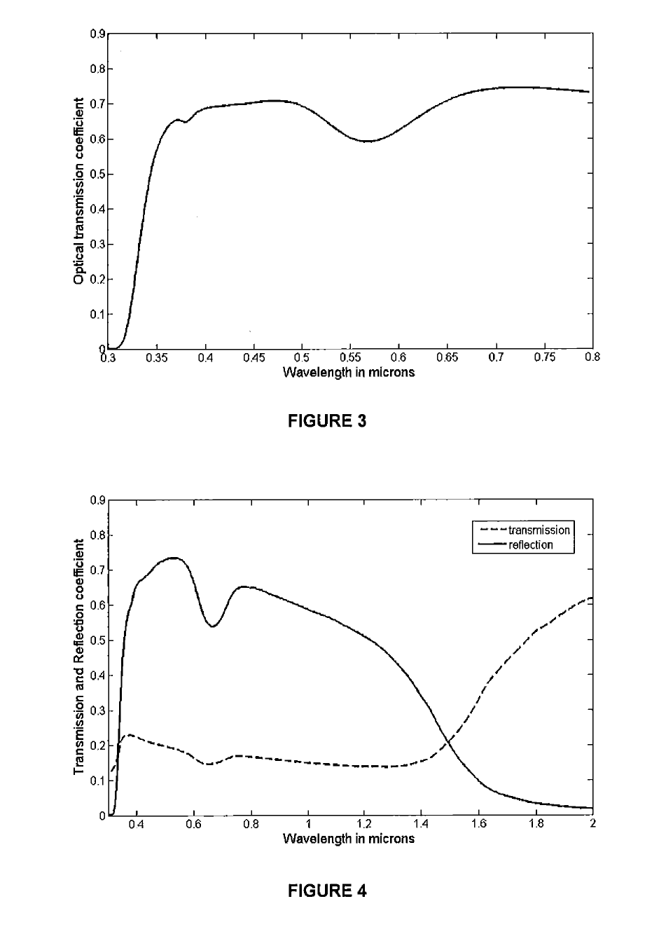

FIG. 3 illustrates measured transmission spectrum of a fluorine doped tin oxide film with embedded gold nanoparticles deposited using the spray coating process according to the invention. The colouration is derived from the plasmon absorption in the visible part of the spectrum.

FIG. 4 illustrates spectral normal reflectance R and transmittance T computed from quantitative data of the optical properties of the corresponding film of 2% aluminium doped zinc oxide embedded with 0.5% gold nanoparticles according to the invention.

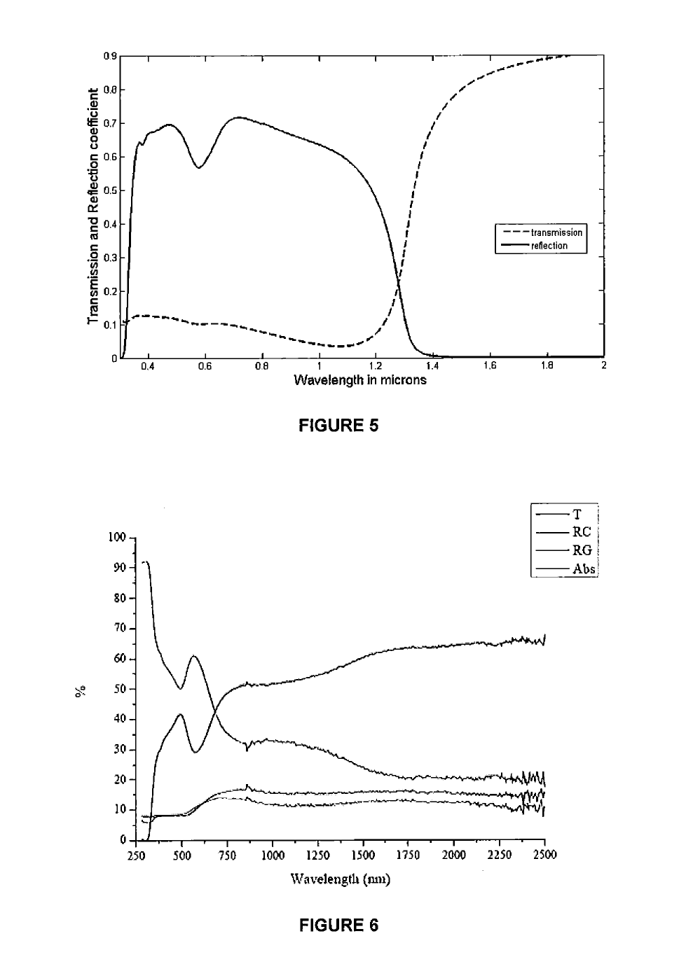

FIG. 5 illustrates spectral normal reflectance R and transmittance T computed from quantitative data of the optical properties of the corresponding film of fluorine doped tin oxide embedded with 0.5% gold nanoparticles according to the invention.

FIG. 6 illustrates the measured optical properties (transmission, coated and glass side reflection and absorption) of Example 3.

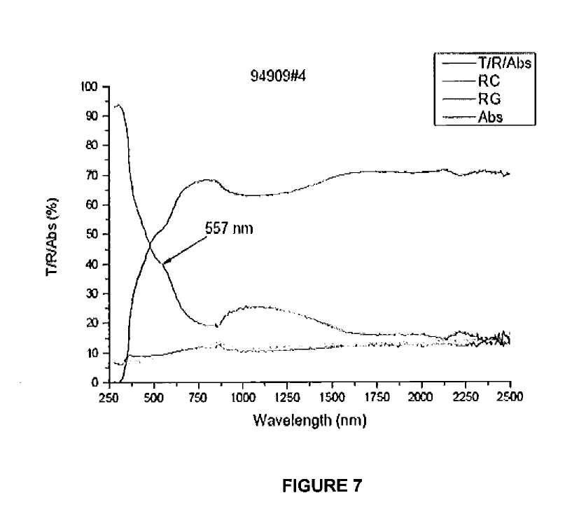

FIG. 7 illustrates the measured optical properties of Example 4.

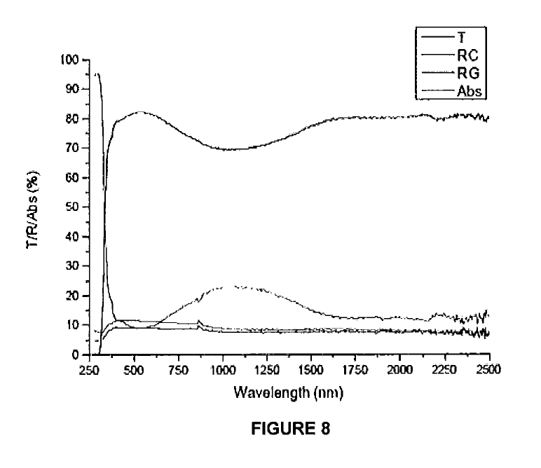

FIG. 8 illustrates the measured optical properties of Comparative Example 1.

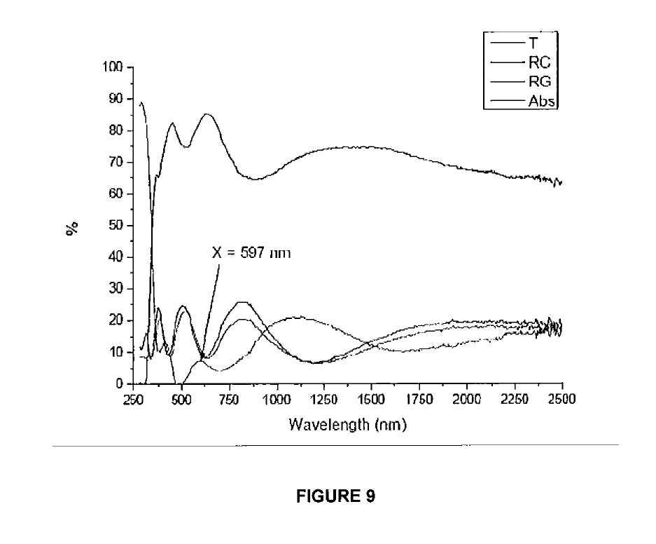

FIG. 9 illustrates the measured optical properties of Example 5.

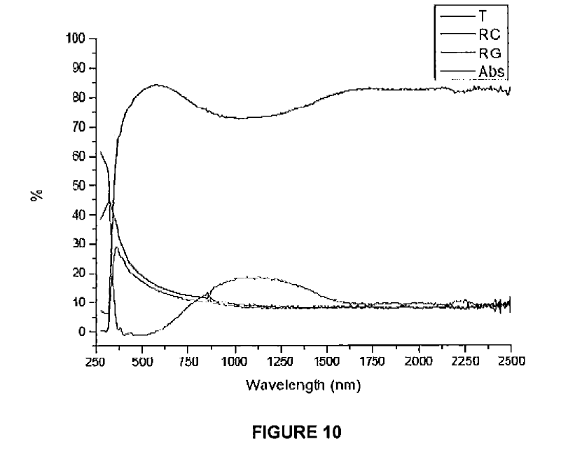

FIG. 10 illustrates the measured optical properties of Example 6.

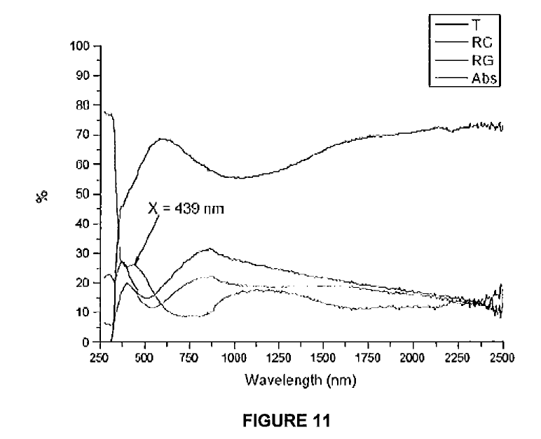

FIG. 11 illustrates the measured optical properties of Example 7.

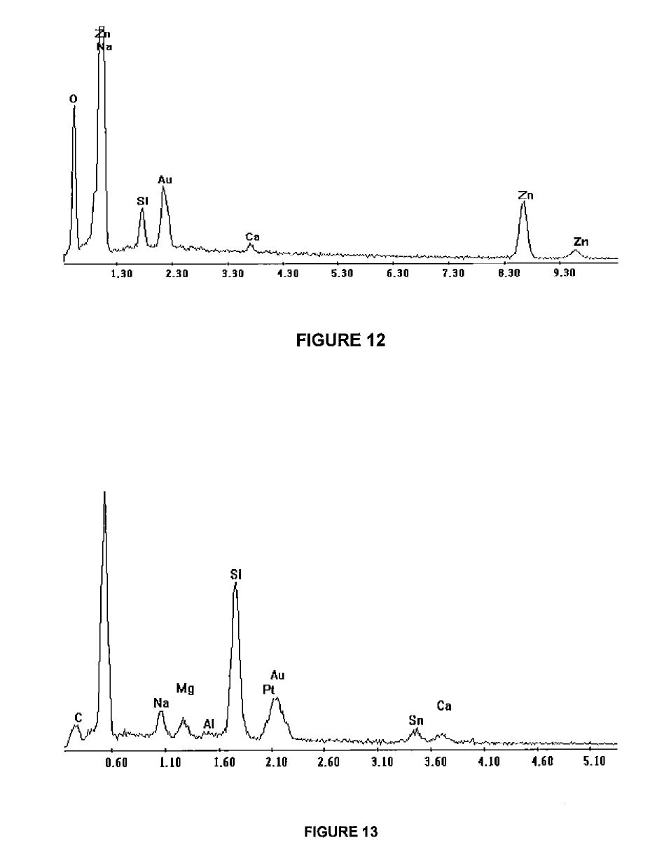

FIG. 12 illustrates the Energy Dispersive Spectrum (EDS) of Example 8.

FIG. 13 illustrates the EDS of Example 9.

The invention is also illustrated by the following Examples.

### EXAMPLE 1

### Experimental Verification of Colouration of Glass

A precursor solution is spray deposited onto a heated glass substrate to obtain a single layer of tin oxide embedded with gold nanoparticles to achieve a robust and durable film suitable for large area window glass. The substrate temperature was held at 330-370 degree C. The precursor includes aminobenzoate stabilized gold nanoparticles and monobutyltin trichloride in ethanol. FIG. 3 shows the corresponding transmission spectrum with the plasmon absorption arising from the nanoparticles clearly visible as a dip in the transmission in the visible part of the spectrum, leading to a purple-blue coloured film. Similar results have been demonstrated, for example, with gold/titania composite films producing a controllable and aesthetically pleasing blue tint.

### EXAMPLE 2

### Dual Function Films for Both Colour and Infra Red Control Using Different Matrix Materials

FIG. 4 shows reflection and transmission for a single spray deposited layer of aluminium doped zinc oxide embedded with gold nanoparticles. FIG. 5 shows an equivalent layer with gold nanoparticles in a fluorine doped tin oxide layer. The solar control performance relates to the extent and position of the plasma edge reflection (i.e. rapid decrease in transmission, increase in reflection). The closer the edge is to the red end of the visible spectrum the better. This is controlled by the impurity doping of the matrix film.

### EXAMPLES 3 TO 8 AND COMPARATIVE EXAMPLES 1 AND 2

These Examples and Comparative Example were produced on a large laboratory scale coater capable of coating glass substrates 300 mm×750 mm by flame, spray or CVD coating. All gold and silver nanoparticles or solutions of nanoparticles were obtained from the Johnson Matthey Technical Centre at Sonning Common.

### EXAMPLE 3

### Coatings from Au Nanoparticles with Al-Ligand (Au—Al2O3)

General Spray Conditions Used:

Fluid pressure—1 bar
Atomising pressure—1 bar
Fan air pressure—1 bar
Glass temperature 300-550° C. (best coatings were obtained between 300-350° C.)

Solution: 0.1% w/v Au nanoparticles, stabilised with Al containing aminobenzoate ligand, in ethanol. The solution was sonicated for 1 hour prior to use and the pH adjusted to 1-2 with HNO₃.

With 1 pass beneath the spray head at 300° C. a thick transparent coating was obtained on the float glass substrate. This was coloured (light blue-grey). Colouration was due to the gold nanoparticles and the presence of a weak absorption band in the optical spectrum (due to the gold surface plasmon resonance). The Au nanoparticles are thought to be embedded in an aluminium oxide matrix (formed from the decomposition of the aluminium containing stabilising ligand). With 3 passes at 350° C. a thick transparent coating was obtained on the float glass substrate. This was also coloured (light blue-grey) . . . ) as described in Table 1 and illustrated in FIG. 6. Strong colouration was due to the gold nanoparticles and the presence of a strong absorption band in the optical spectrum (due to the gold surface plasmon resonance).

TABLE 1

| | T | RC | RG |
|---|---|---|---|
| L* | 64.7 | 37.0 | 38.1 |
| a* | −3.2 | 6.9 | 4.8 |
| b* | −5.7 | 4.8 | 6.0 |

### COMPARATIVE EXAMPLE 1

### Coatings from Mixed Chloro-Zinc-4-Aminobutanoate+Au/Al Solution

An attempt was made to deposit a coating from a solution of chloro-zinc-4-aminobutanoate+Au/Al solution. This gave a coloured coating of gold nanoparticles embedded in a zinc oxide/aluminium oxide matrix, but this was not uniform and was of unacceptable quality.

### EXAMPLE 4

### Coatings from Chloro-Zinc-4-Aminobutanoate+Au(Al) NPs

General spray conditions used: Fluid pressure—0.1 bar Atomising pressure—1 bar Fan air pressure—1 bar Furnace temperature—500° C. Glass speed—36 m/h

Solution—1:1 mixture of 0.1 M chloro-zinc-4-aminobutanoate solution in ethanol+0.1% w/v Au(Al) NPs in ethanol

With 5 passes beneath the spray head a thin coloured and transparent coating was obtained on the float glass substrate.

Optical analysis indicates the presence of a Surface Plasmon Resonance band at 557 nm and this is reflected in the transmitted colour co-ordinates (see Table 2 and FIG. 7). XRD analysis has also confirmed the presence of large amounts of Gold.

TABLE 2

| | T | RC | RG |
|---|---|---|---|
| L* | 77.5 | 35.3 | 36.9 |
| a* | 2.1 | 2.4 | 1.8 |
| b* | 12 | 4.8 | 2.2 |

### COMPARATIVE EXAMPLE 2

### Coatings from Zinc N,N-dimethylglycine+Zn/Al Aromatic Precursor

General spray conditions used: Fluid pressure—0.1 bar Atomising pressure—1 bar Fan air pressure—1 bar Furnace temperature—500° C. Glass speed—36 m/h

Solution—6% w/v Aluminium chloride-nitro-pyridine-Zinc-diacetate precursor in hexylethanoate in 0.1 M zinc N,N-dimethylglycine solution in EtOH. Zn/Al precursor structure is shown in Figure.

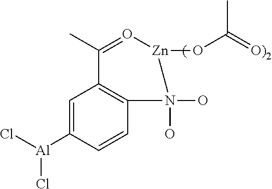

With 3 passes beneath the spray head a transparent coating was obtained on the float glass substrate.

XRD analysis confirmed the coating was zinc oxide and optical analysis was also consistent with an undoped zinc oxide coating. There was no evidence of aluminium and the film was non conductive (i.e. doping using the Zn/Al aromatic precursor was unsuccessful, probably due to the long organic chain separating the Zn and Al). SEM cross section images show that there is a thin continuous layer that is approximately 360 angstroms thick.

### EXAMPLE 5

### Coatings Using Surchem E1 (FTO)+Au NPs

Coatings were deposited from a solution containing monobutyl tin trichloride and trifluoroacetic acid in ethanol (Surchem E1). When sprayed this solution gives a fluorine-doped tin oxide coating that is electrically conducting. Preformed gold nanoparticles were added to the solution to give a blue colouration (see Table 3 and FIG. 9). An SPR band was observed at 597 nm that is consistent with nanoparticle inclusion in the host metal oxide coating.

General spray conditions used: Fluid pressure—0.1 bar Atomising pressure—1 bar Fan air pressure—1 bar Furnace temperature—500° C. Glass speed—36 m/h

Solution—1:1 mixture of Surchem E1 solution+0.1% w/v Au NPs in H₂O. Au nanoparticles were stabilised using aminobenzoate ligand deprotonated by triethylamine.

TABLE 3

| | T | RC | RG |
|---|---|---|---|
| L* | 91.1 | 48.4 | 48.3 |
| a* | 5.0 | −27.0 | −24.8 |
| b* | −1.2 | 6.5 | 11.4 |

### EXAMPLE 6

### Coatings Using Surchem SG1 (TiO2) Solution+Ag

Coatings were deposited from a solution containing a mixture of titanium tetra ethoxide and titanium tetra isopropoxide (Surchem SG1). When sprayed this gives a titanium dioxide coating. Preformed silver nanoparticles were added to the solution to give a blue colouration (see Table 4).

General spray conditions used: Fluid pressure—0.1 bar Atomising pressure—1 bar Fan air pressure—1 bar Furnace temperature—500° C. Glass speed—36 m/h

Solution 1:1 mixture of Surchem SG1 solution+0.1% w/v Ag nanoparticles in H₂O. Ag nanoparticles stabilised by aminobenzoate ligand deprotonated by triethylamine

TABLE 4

| | T | RC | RG |
|---|---|---|---|
| L* | 93.1 | 48.4 | 46.2 |
| a* | −1.0 | −0.5 | −0.9 |
| b* | 3.6 | −10.5 | −9.3 |

### EXAMPLE 7

### Coatings Using Surchem SG1 (TiO2) Solution+Au

Coatings were deposited from a solution containing a mixture of titanium tetra ethoxide and titanium tetra isopropoxide (Surchem SG1). When sprayed this gives a titanium dioxide coating. Preformed gold nanoparticles were added to the solution to give a blue colouration (see Table 5 and FIG. 11). An SPR band was observed at 439 nm that is consistent with nanoparticle inclusion in the host metal oxide coating.

General spray conditions used: Fluid pressure—0.1 bar Atomising pressure—1 bar Fan air pressure—1 bar Furnace temperature—500° C. Glass speed—36 m/h

Solution 1:1 mixture of Surchem SG1 solution+0.1% w/v Au nanoparticles in H₂O. Au nanoparticles stabilised by aminobenzoate ligand deprotonated by triethylamine

TABLE 5

| | T | RC | RG |
|---|---|---|---|
| L* | 85.0 | 47.9 | 42.4 |
| a* | −0.9 | 9.2 | 7.1 |
| b* | 9.4 | −4.1 | −9.6 |

### EXAMPLES 8 AND 9

These examples were deposited on a production coater by spray deposition. The coater is capable of temperatures of up to 650° C. in the open atmosphere. The complete system sits directly over the glass ribbon and its footprint is approximately 1.5 m×1.5 m.

### EXAMPLE 8

This was deposition of a zinc oxide/Au nanoparticle coating using solution 5-720 g Zn-2-EtOHx+200 mL HxOAc+200 mL 1 wt % Au in ethanol, stabilised using aminobenzoate ligand at a flow rate of 0.07 L/min.

The deposited coating was approximately 168 nm thick and contained gold (see FIG. 12).

### EXAMPLE 9

This was deposition of a tin oxide/Au nanoparticle coating/approximately 43 nm thick. Au nanoparticles were supplied as ethanolic solutions, stabilised by aminobenzoate ligands.

The precursor solution (solution 4) was prepared as 100 cm³ of solution 2 with 900 cm³ of 0.4 wt % Au preformed nanoparticle solution. Solution 2 was 44.5 L of solution 1 and 750 cm³ 0.4 wt % Au solution. Solution 1 was 50 kg Surchem E1 solution and 2 L 0.4 wt % Au solution. Solution 4 was delivered at a flow rate of 0.1 L/Min.

The coating contains gold as shown in FIG. 13.

1-23. (canceled)

24. A method for coating a substrate, the method comprising,
a) providing a substrate
b) providing pre-formed nanoparticles having a particle size of 1 to 300 nm of an inorganic material,
c) providing at least one precursor of doped tin oxide, and
d) depositing a coating on at least one surface of the substrate, by contacting the surface with the precursor of doped tin oxide and pre-formed nanoparticles.

25. The method as claimed in claim 24, wherein the coating method comprises depositing the coating as nanoparticles in a matrix of doped tin oxide.

26. The method as claimed in claim 24, wherein the substrate is a transparent or translucent substrate.

27. The method as claimed in claim 26, wherein the substrate comprises glass or plastics.

28. The method as claimed in claim 24, wherein the inorganic material comprises a metal.

29. The method as claimed in claim 28, wherein the metal is a d-block metal.

30. The method as claimed in claim 29, wherein the metal is a platinum group metal or a coinage metal.

31. The method as claimed in claim 30, wherein the metal is selected from Au, Ag, Cu, Ni, Pd, Pt or an alloy thereof.

32. The method as claimed in claim 24, wherein the preformed nanoparticles are contained within an inorganic matrix.

33. The method as claimed in claim 32, wherein the inorganic matrix comprises a matrix metal oxide.

34. The method as claimed in claim 33, wherein the matrix metal oxide is doped tin oxide.

35. The method as claimed in claim 24, wherein the doped tin oxide is doped with Al, Ga, F, N, Nb or Sb.

36. The method as claimed in claim 24, wherein the doped tin oxide is electrically conductive.

37. The method as claimed in claim 24, wherein the doped tin oxide is substantially transparent.

38. The method as claimed in claim 24, wherein the nanoparticles have a particle size of 1 nm to 150 nm, preferably 5 to 100 nm, more preferably 10 to 80 nm and most preferably 20 to 50 nm.

39. The method as claimed in claim 24, wherein the coating has a thickness of 20 to 300 nm.

40. The method as claimed in claim 24, wherein the method for coating is selected from chemical vapour deposition, spray pyrolysis, aerosol spray pyrolysis, and/or flame spraying.

41. The method as claimed in claim 24, wherein the surface of the substrate is at a temperature in the range 80° C. to 750° C., preferably 100° C. to 650° C., more preferably 100° C. to 600° C., most preferably 100° C. to 550° C.

42. A substrate having a coating, the coating comprising a doped tin oxide and pre-formed nanoparticles having a particle size of 1 to 300 nm of an inorganic material.
